(19) United States
(12) Patent Application Publication
(10) Pub. No.: US 2019/0364890 A1
(43) Pub. Date: Dec. 5, 2019

(54) SYNERGISTIC COMBINATION OF ORTHO-PHENYLPHENOL AND BIS-(3-AMINOPROPYL)DODECYLAMINE

(71) Applicant: Dow Global Technologies LLC, Midland, MI (US)

(72) Inventors: Patrick T. Felder, Horgen (CH); Emmanuelle Christine Yvon, Horgen (CH); Alessandro Vezzoli, Horgen (CH); Maciej Szymeczko, Horgen (CH)

(21) Appl. No.: 16/468,578

(22) PCT Filed: Oct. 25, 2017
(86) PCT No.: PCT/US2017/058178

§ 371 Date: Jun. 11, 2019

Related U.S. Application Data
(60) Provisional application No. 62/437,364, filed on Dec. 21, 2016.

(51) Int. Cl. A01N 31/08; A01N 33/04

(52) U.S. Cl. CPC A01N 31/08; A01N 33/04

(57) ABSTRACT

A synergistic antimicrobial composition containing ortho-phenylphenol and its salts and bis-(3-aminopropyl)dodecylamine is provided. Also, a method of inhibiting the growth of or controlling the growth of microorganisms in an aqueous medium and an aqueous based product is further provided.

This invention relates to combinations of biocides, the combinations having greater activity than would be observed for the individual antimicrobial compounds.

Use of combinations of at least two antimicrobial compounds can broaden potential markets, reduce use concentrations and costs, and reduce waste. In some cases, commercial antimicrobial compounds cannot provide effective control of microorganisms, even at high use concentrations, due to weak activity against certain types of microorganisms, or relatively slow antimicrobial action, or instability under certain conditions such as high temperature and high pH. Combinations of different antimicrobial compounds are sometimes used to provide overall control of microorganisms or to provide the same level of microbial control at lower use rates in a particular end use environment. Additionally, synergy has been found to be an unpredictable phenomenon. Often like compounds display varying synergistic profiles when combined with a particular active. It may be that no synergy is evidenced or it may be that synergy exists but over a different synergistic range. Because of this observation, it is difficult, if not impossible to draw conclusions regarding the synergistic profile of one compound based upon the synergistic profile of a like compound. Thus more synergistic combinations and their synergistic ranges must be discovered.

One such example of synergy is found in U.S. Pat. App. Pub. No. 2007/0078118. This reference discloses synergistic combinations of N-methyl-1,2-benzisothiazolin-3-one (MBIT) with other biocides. There still exists a need for additional combinations of antimicrobial compounds having enhanced activity to provide effective control of microorganisms. The problem addressed by this invention is to provide such combinations of antimicrobial compounds.

In the present invention there is provided a synergistic antimicrobial composition comprising ortho-phenylphenol and bis-(3-aminopropyl)dodecylamine (also known as BDA or diamine or triamine) (CAS registry number is 2372-82-9).

The invention further provides a method of inhibiting the growth of or controlling the growth of microorganisms in an aqueous medium, the method comprising the step of adding a synergistic antimicrobial composition comprising OPP and BDA.

The following is a detailed description of the invention.

As used herein, the following terms have the designated definitions, unless the context clearly indicates otherwise.

The term “antimicrobial compound” refers to a compound capable of inhibiting the growth of or controlling the growth of microorganisms; antimicrobial compounds include bactericides, bacteriostats, fungicides, fungistats, algaecides and algistats, depending on the dose level applied, system conditions and the level of microbial control desired. Such term “antimicrobial compound” as used herein is synonymous with the term “biocide”.

The term “microorganism” includes, for example, fungi (such as yeast and mold), bacteria and algae.

The following abbreviations are used throughout the specification: ppm=parts per million by weight (weight/weight), mL=milliliter, ATCC=American Type Culture Collection, DSMZ=Deutsche Sammlung von Mikroorganismen und Zellkulturen, and MIC=minimum inhibitory concentration.

Unless otherwise specified, temperatures are in degrees centigrade (° C.), and references to percentages are by weight (wt. %). Percentages of antimicrobial compounds in the composition of this invention are based on the total weight of active ingredients in the composition, i.e., the antimicrobial compounds themselves, exclusive of any amounts of solvents, carriers, dispersants, stabilizers or other materials which may be present.

As used herein, “OPP” is ortho-phenylphenol (OPP) and it salts. Suitably, OPP is sodium ortho-phenylphenate (also known as NaOPP) (CAS registry number is 132-27-4 (and 6152-33-6)).

As used herein, “BDA” is bis-(3-aminopropyl)dodecylamine (also known as diamine) (CAS registry number is 2372-82-9)

When a ratio is the herein to be “X:1 or higher,” it is meant that the ratio is Y:1, where Y is X or greater, and when a ratio is the herein to be “X:1 or lower,” it is meant that the ratio is Z:1, where Z is X or less. The same logic follows for ratios that are “1:X or higher” and “1:X or lower”.

The present invention is a composition that contains both OPP and BDA. It has been surprisingly found that compositions that contain both OPP and BDA are synergistically effective as biocides. In the present invention, the weight ratio of the OPP to BDA is from 1:1 to 100:1 alternatively from 1:1 to 10:1 and further alternatively from 10:1 to 100:1.

In some embodiments of the invention, the antimicrobial combination of this invention is useful for inhibiting the growth of or controlling the growth of microorganisms in an aqueous medium. Such aqueous media include but is not limited to industrial water and water containing/contaminated media, such as cooling water, air washer, heat exchangers, boiler water, pulp and paper mill water, other industrial process water media such as: ballast water, wastewater, metalworking fluids, oil and gas, latex, paint, coatings, adhesives, inks, tape joint compounds, pigment, water-based slurries, personal care and household products such as detergent, filtration systems (including reverse osmosis and ultrafiltration systems), toilet bowel, textiles, leather and leather production system, or a system used therewith. In one embodiment the antimicrobial composition is used as an in-can preservative.

Typically, the amount of the biocide combinations of the present invention for inhibiting the growth of or controlling the growth microorganisms is from 10 ppm to 5,000 ppm active ingredient. In some embodiments of the invention, the active ingredients of the composition are present in an amount of at least 20 ppm, alternatively at least 50 ppm, alternatively at least 100 ppm, alternatively at least 150 ppm, alternatively at least 200 ppm. In some embodiments, the active ingredients of the composition are present in an amount of no more than 2,000 ppm, alternatively no more than 1,000 ppm, alternatively no more than 500 ppm, alternatively no more than 400 ppm, alternatively no more than 300 ppm, alternatively no more than 250 ppm, alternatively no more than 200 ppm, alternatively no more than 100 ppm, alternatively no more than 50 ppm. Concentrations mentioned above are in a liquid composition containing the biocide combinations.

The present invention also encompasses a method for inhibiting the growth of or controlling the growth of microorganisms in the use areas described above, especially in in-can preservative applications, by incorporating the claimed biocide combination into the materials.

The composition of the present invention contains OPP and BDA. It is contemplated that some embodiments may contain one or more additional antimicrobial compound.

The following are examples of the present invention.

### EXAMPLES

The synergism of the biocides combination of the present invention was determined using the Minimum Inhibitory (MIC) test method described by Kull, F. C., et. al in Applied Microbiology 9:538-541 (1961).

The formula to calculate the synergy index (SI) is

SI=Qa/QA+Qb/QB

### Where

QA=minimum inhibitory concentration in ppm of compound A acting alone
Qa=minimum inhibitory concentration in ppm of compound A in the mixture.
QB=minimum inhibitory concentration in ppm of compound B acting alone.
Qb=minimum inhibitory concentration in ppm of compound B in the mixture.

Synergism of two biocides is demonstrated when the SI has a value less than 1. The mixtures showed an additive effect if SI is equal to 1 and antagonistic if SI is greater than 1.

The Minimum Inhibitory Concentration Test (MIC) is designed to evaluate the lowest concentration of a biocide, biocide blend or biocide combination to prevent bacteria growing in a defined broth.

### Minimum Inhibitory Concentration (MIC) Testing Protocol:

The MICs of the single biocides NaOPP and BDA as well as of combinations of these two actives (all in TSB) in 3 different ratios (1:1; 10:1, 100:1) were estimated against each of the 4 microorganisms Staphylococcus aureus (DSMZ#799), Pseudomonas aeruginosa (DSMZ#939) and Candida albicans (DSMZ#1386), Pseudomonas putida, respectively.

Although the efficacy can vary significantly against different microorganisms the same starting biocide levels were chosen for all strains (3′000 ppm for single NaOPP, 200 ppm for single BDA and 200 ppm/200 ppm, 2′000 ppm/200 ppm and 3′000 ppm/30 ppm for the combinations 1:1, 10:1 and 100:1, respectively).

The synergy testing was carried out as follows:
1. The test was executed with a Hamilton MLStarPlus robot using automated turbidity reading with BioTek Synergy H4 plate reader.
2. Biocide systems were prepared in 2.2 ml deep well plates by transferring and diluting biocides from stock solutions to first rows of the plates. The concentrations of biocides in stock bottles were adjusted to be 20× more concentrated than the highest desired concentration.
3. Then 15 subsequent serial dilutions with dilution factor 1.3 were performed resulting in 16 different concentrations for each system.
4. In the next step serially diluted biocide systems were transferred to the media blocks containing 850 μl of TSB medium adjusted to pH 5. For each biocide system 100 μl was transferred to the media, resulting in 950 μl of final volume of media+biocides and 9.5 times dilution of the biocides from the biocide plate. At this point, the concentrations of all biocides in media were 1.053×final concentration.
5. After preparation and mixing of the described systems, 4 aliquots of 190 μl were prepared in 96-well microtiter plates.
6. Preparation of the microbe suspension:

Bacterial Cultures:

| | | |
|---|---|---|
| Pseudomonas aeruginosa | DSM # 939 | ATCC# 15442 |
| Staphylococcus aureus | DSM # 799 | ATCC# 6538 |
| Pseudomonas putida | n/a | n/a |

The culture was maintained as a glycerol stock at −80° C. in cryovials. A cryovial was thawed and then 100 μl spread on a TSA agar plate. After incubation for 1 day at 30° C. the bacteria were harvested with buffer at pH 7.3. A total viable count on TSA plate was carried out and bacterial suspension was diluted in buffer in order to deliver ˜2×10⁷ CFU/ml.

Yeast Culture:

| | | |
|---|---|---|
| Candida albicans | DSM #1386 | ATCC# 10231 |

The cultures were maintained as glycerol stocks at −80° C. in cryovials, are thawed and then 100 μl spread on MEA (malt extract agar) petri dishes.
The yeast strain plates were incubated at 28° C. for 1-2 days then harvested with buffer pH 5.0.
Based on total viable count results, the inoculum was prepared.
7. Each test sample (190 μl) was inoculated with the 10 μl of microbe suspension to provide a level of ˜1×10⁶ CFU/ml of the bacteria species and ˜1×10⁵ CFU/ml of the yeast species.
8. The test samples were mixed and incubated at 30° C. for 2 days (48 hours) when tested against bacteria and 3 days (72 hours), respectively, when tested against yeast.
9. Growth of the micro-organisms leads to turbidity after incubation, clarity indicates no growth. Reading of the results was carried out by measuring absorbance at 600 nm for each sample at the beginning of the test (t_{zero}) and after incubation (t_{endpoint}). t_{endpoint} was chosen at 48 hours for bacteria and 72 hours for yeast. The difference in absorbance between t_{endpoint} and t_{zero} was used to assign a score (“1” if Δ>0.2, confirming growth, and “0” if Δ≤0.2, confirming no growth) from which the MIC values were derived. The lowest concentration that showed no growth (score of “0”) in the broth after incubation is taken as the MIC value.

The MIC's of single biocide and combinations thereof as well as the synergy indices are presented in Tables 1, 2, and 3.

TABLE 1
MIC results for single biocides (in ppm):

Active ingredients [ppm]

| | NAOPP | BDA |
|---|---|---|
| Staphylococcus aureus DSM# 799 | 129 | 91 |
| Pseudomonas aeruginosa DSM# 939 | 167 | 200 |
| Candida albicans DSM# 1386 | 167 | ≥260^{a} |
| Pseudomonas putida | 283 | 200 |

^{a}The MIC couldn't be determined as there was still growth at the highest tested concentration of the active. The MIC indicated is an estimation and represents the next higher concentration (1.3x) than tested. It is likely that the actual MIC is greater than the value indicated.

TABLE 2
MIC results for combinations of two biocides (in ppm)

| | NAOPP/ | | NAOPP/ | | NAOPP/ | |
|---|---|---|---|---|---|---|
| | BDA | | BDA | | BDA | |
| Active ingredients | 1 | 1 | 10 | 1 | 100 | 1 |
| Staphylococcus | 32 | 32 | 66 | 6.6 | 99 | 1.0 |
| aureus DSM# 799 | | | | | | |
| Pseudomonas | 25 | 25 | 66 | 6.6 | 99 | 1.0 |
| aeruginosa | | | | | | |
| DSM# 939 | | | | | | |
| Candida albicans | 41 | 41 | 66 | 6.6 | 59 | 0.6 |
| DSM# 1386 | | | | | | |
| Pseudomonas putida | 41 | 41 | 86 | 8.6 | 129 | 1.3 |

TABLE 3
Calculated synergy indices for the combinations in Table 2

| Ratio NAOPP:BDA | 1:1 | 10:1 | 100:1 |
|---|---|---|---|
| Staphylococcus aureus DSM# 799 | 0.6 | 0.6 | 0.8 |
| Pseudomonas aeruginosa DSM# 939 | 0.3 | 0.4 | 0.6 |
| Candida albicans DSM# 1386 | ≤0.4^{b} | ≤0.4^{b} | ≤0.4^{b} |
| Pseudomonas putida | 0.4 | 0.4 | 0.5 |

^{b}The Synergy Index is calculated based on a theoretical MIC value of BDA (see ^{a}) or on theoretical MIC values of NaOPP:BDA(10:1); the actual synergy index is less than or equal to the value calculated in the table.

1. A synergistic antimicrobial composition comprising ortho-phenylphenol or its salts and bis-(3-aminopropyl)dodecylamine.

2. The synergistic antimicrobial composition of claim 1, wherein the weight ratio of the ortho-phenylphenol or it salts to bis-(3-aminopropyl)dodecylamine is from 1:1 to 100:1.

3. An aqueous-based product comprising the synergistic antimicrobial composition of claim 1.

4. An aqueous-based product comprising the synergistic antimicrobial composition of claim 2.

5. A method of inhibiting the growth of or controlling the growth of microorganisms in the aqueous-based product of claim 4.

6. The method of claim 5 wherein the aqueous-based product is used in aqueous systems selected form the group consisting of cooling water, air washer, heat exchangers, boiler water, pulp and paper mill water, ballast water, wastewater, metalworking fluids, oil and gas, latex, paint, coatings, adhesives, inks, tape joint compounds, pigment, water-based slurries, personal care products, detergent, filtration systems, toilet bowel, textiles, leather and leather production system.
